(19) United States
(12) Patent Application Publication
(10) Pub. No.: US 2021/0179979 A1
(43) Pub. Date: Jun. 17, 2021

(54) METHOD OF TREATING A SUBSTRATE WITH A MULTIPLICITY OF SOLID PARTICLES

(71) Applicant: Xeros Limited, Rotherham, South Yorkshire (GB)

(72) Inventors: Lars Frederik Paul SERVIN, Rotherham (GB); Robert Andrew BIRD, Rotherham (GB)

(21) Appl. No.: 17/271,497

(22) PCT Filed: Aug. 30, 2019
(86) PCT No.: PCT/GB2019/052427

§ 371 Date: Feb. 25, 2021

(30) Foreign Application Priority Data
Aug. 31, 2018 (GB) 1814181.2

(51) Int. Cl. C11D 17/00; C11D 3/37; C11D 11/00; C11D 3/00

(52) U.S. Cl. CPC C11D 17/0013; C11D 3/0047; C11D 11/0017; C11D 3/3715

(57) ABSTRACT

A method of treating a substrate comprising a first step of agitating a composition comprising solid particles comprising biodegradable polyester having a number-average molecular weight of from 10,000 Daltons to 500,000 Daltons, said solid particles having a size of from 0.1 mm to 100 mm; a liquid medium; and the substrate, and a second step comprising separating the solid particles from the substrate.

### FIELD OF THE INVENTION

The present disclosure relates to a method of treating a substrate using solid particles comprising a biodegradable polyester.

### BACKGROUND TO THE INVENTION

The treatment of substrates using solid particles is finding application in a number of technical fields. The solid particles provide effective cleaning and processing whilst offering environmental and economic advantages over many conventional treatment methods. PCT patent publication WO-2007/128962-A discloses solid cleaning particles for the cleaning of substrates using solvent-free methods to avoid environmental concerns associated with solvent processing. The publication teaches methods of treating substrates, particularly textiles, with Nylon 6,6 solid cleaning particles. The publication addresses environmental concerns which pertain to toxic and potentially environmentally harmful halocarbon solvents. PCT patent publication WO-2014/167359-A discloses a tanning technology which comprises a method for treating animal substrates, such as skins, using for example polyethylene terephthalate polymeric particles with tanning agents. Both publications clearly demonstrate economic advantages such as low water consumption and low energy use. These publications also provide for the particles being recovered and reused multiple times in the treatment method.

The present application inventors, after extensive experimentation, determined several areas where further improvements were sought. In particular, the present inventors sought to improve the biodegradability of the solid particles. In this way the solid particles need not necessarily be recycled at the end of their useful service lifetime but could optionally also be biodegraded in the natural environment. The present inventors also sought to improve the effectiveness of the separation of the solid particles from the substrate. The present inventors surprisingly found that biodegradable polyesters provided both good biodegradability and good separability from the substrate. The present inventors also found that by carefully controlling the number average molecular weight, the biodegradability could be retained whilst simultaneously permitting the treatment methods to be repeated many times using the same solid particles. Such a simultaneous achievement was surprising because it would have been expected that any molecular weight which permitted biodegradation (e.g. in the natural environment) would result in solid particles which could not be re-used many times before they became unusable in the desired method.

### SUMMARY OF THE INVENTION

According to a first aspect of the present invention there is provided a method of treating a substrate comprising a first step of agitating a composition comprising solid particles comprising biodegradable polyester having a number-average molecular weight of from 10,000 Daltons to 500,000 Daltons, said particles having a size of from 0.1 mm to 100 mm; a liquid medium; and the substrate, and a second step comprising separating the solid particles from the substrate.

Preferably, treating is or comprises or consists of:

i. cleaning, more preferably laundering;

ii. tanning and tannery processes; or

iii. one or more of dyeing, abrading, fading, desizing and biofinishing.

Of these options i. is especially preferred.

It will be appreciated that cleaning means cleaning the substrate.

Similarly, tanning means tanning the substrate. Similarly, dyeing, abrading, fading, desizing and biofinishing all mean dyeing, abrading, fading, desizing and biofinishing the substrate.

Tanning includes tanning and re-tanning

Preferably, the method of treating is applicable to those technologies where the method itself is conducted in a closed apparatus. The method according to the first aspect of the present invention is preferably able to reduce water consumption relative to conventional processes. This provides the present invention with the ability to work in a sustainable and more environmentally friendly way.

Solid Particles Comprising Biodegradable Polyester

Biodegradable polyesters are a specific type of polyester that preferably break down after their intended purpose to yield natural by-products. In the case of poly(lactic acid) or poly(lactide), biodegradation produces lactic acid which is a natural product of anaerobic respiration and can be found in, for example, sour milk.

Preferably, the solid particles comprise at least 30 wt %, preferably at least 40 wt %, preferably at least 50 wt % biodegradable polyester. The solid particles may contain at least 55 wt %, at least 60 wt %, at least 65 wt %, at least 70 wt %, at least 80 wt %, at least 90 wt % or at least 95 wt % biodegradable polyester.

Optionally, the solid particles comprise a filler.

Preferably, when present the filler is inorganic. More preferably, the filler is an inorganic salt. A preferred inorganic salt is barium sulfate.

The presence of the filler increases the density of the solid particles comprising biodegradable ester and can aid in the separation of the solid particles. Preferably, the filler is benign, which in this context preferably means non-reactive and non-toxic to the environment.

Preferably, the solid particles comprise no more than 70 wt %, more preferably no more than 60 wt % and especially no more than 50 wt % of filler.

Preferably, the solid particles comprise at least 5 wt % of filler.

Preferably, the solid particles comprise biodegradable polyester and a filler in a weight ratio of from 99:1 to 20:80 and more preferably, of from 99:1 to 30:70 (biodegradable polyester:filler).

The solid particles can comprise at least 5 wt %, at least 10 wt %, at least 20 wt %, at least 30 wt %, at least 35 wt %, at least 40 wt %, at least 45 wt % or at least 50 wt % of filler, which is preferably an inorganic filler. Optionally, the solid particles comprise at least 20 wt % filler, particularly where faster and/or more efficient separation of the solid particles from the substrate is desired. The remainder of the solid particles required to make 100 wt % is preferably biodegradable polyester.

Alternatively, the solid particles comprise a filler in the amount of from 5 wt % to 50 wt %. The remainder of the solid particles required to make 100 wt % is preferably biodegradable polyester.

Preferably, the solid particles comprise biodegradable polyester and no filler (and in particular no inorganic filler), and in this embodiment the solid particles preferably consist of biodegradable polyester. Such solid particles can be more readily formed into more spherical or ellipsoidal shapes which tend to separate from the substrate more readily. Additionally, such particles are more mechanically robust and less susceptible to abrasion than the corresponding particles containing fillers.

Preferably, at least some and more preferably all of the solid particles have a shape which is ellipsoidal or spheroidal as these shapes tend to be gentler to the substrate surface and tend to separate well from the substrate after performing the methods described herein. Most preferably, the solid particles have few or no edges or vertices. Preferably, the surfaces of the solid particles are entirely smooth. A preferred smooth surface comprises or consists of a curvilinear surface. Preferably, the solid particles have surfaces which are also free from pores, for example when viewed under an optical microscope, for example at 100× magnification.

Preferably, the solid particles comprise no releasable material. Where releasable material is present, then any releasable material is preferably not a cleaning, post-cleaning or treatment additive for the treatment of the substrate. It will be appreciated that the term “releasable material” does not refer to said biodegradable polyester, i.e. the “releasable material” is a material which is different to said biodegradable polyester. Releasable material as used herein preferably means any material which is released from the solid particles into the liquid medium. One preferred test to establish the absence of any releasable material is to add 1 g of the solid particles to 10 g of deionized water and to stir gently to form a mixture. The deionized water preferably has a pH of from 5 to 7. The mixture is then stored for 24 hours at a temperature of 20° C. 1 g of the water is then isolated from the mixture and dried. The weight of any material in the liquid medium should preferably be zero, negligible or practically unmeasurable. Thus, it can be assessed and confirmed that no material was released from the solid particles.

Preferably, the term “cleaning or post-cleaning additive” as used herein means cleaning chemicals or post-cleaning chemicals which are typically components of the detergent formulation used in a conventional wash process. Cleaning agents are therefore typically selected from surfactants, enzymes, oxidising agents and bleaches, whilst post-cleaning agents include, but are not limited to, optical brightening agents, anti-redeposition agents, dye-transfer inhibition agents and fragrances. Preferably, the term “treatment additives” as used herein means or includes antimicrobial agents, suitable examples of which include but are not limited to ionic silver containing zeolites, benzalkonium chloride, Triclosan® and silver nitrate.

Said solid particles comprising biodegradable polyester may be used in combination with solid particles comprising or consisting of other polymers. Preferably, however, at least 50% by number and more preferably all of the solid particles present comprise biodegradable polyester.

Preferably, the biodegradable polyester is insoluble in water. By insoluble we preferably mean having a solubility in water of less than 1 wt %, more preferably less than 0.5 wt %, especially less than 0.2 wt %, and especially less than 0.1 wt %. The solubility is preferably assessed in deionized water, preferably having a temperature of 20° C. The solubility is preferably assessed after immersing solid particles in water for a period of 24 hours. The pH of the deionized water is preferably from 5 to 7. In a preferred method the insolubility of the biodegradable polyester is established by: i. adding 1 g of the biodegradable polyester to 10 g of deionized water in a vial; ii. maintaining the temperature of the vial and its contents at 20° C. for a period of 24 hours; iii. agitating the vial and its contents by rolling the vial on rollers; iv. isolating 1 g of water after the 24 hours from the insoluble biodegradable polyester; v. drying the water so isolated in a sample container of exactly known weight by being placed in a vacuum oven at a temperature of 20° C. and exposed to vacuum for a period of 24 hours; vi. weighing the dry sample container including any dry soluble biodegradable polyester and then calculating the weight of the dry soluble biodegradable polyester; vii. calculating the total amount of soluble biodegradable polyester and thereby the wt % of any soluble biodegradable polyester is established; viii. converting the wt % soluble biodegradable polyester into a wt % of insoluble biodegradable polyester. For the purposes of this method any mass of dry soluble polyester which is less than 0.0005 g is regarded as being within experimental error equivalent to zero mass and therefore 100% insoluble.

In order of increasing preference, the solid particles preferably have a density of at least 0.5 g/cm³, at least 0.75 g/cm³, at least 0.9 g/cm³, at least 1.0 g/cm³, at least 1.1 g/cm³ or at least 1.2 g/cm³.

Preferably, the density of the solid particles is from 0.5 g/cm³ to 4.0 g/cm³, more preferably from 1.0 g/cm³ to 3.0 g/cm³, and especially from 1.1 g/cm³ to 3.0 g/cm³ and most especially from 1.1 g/cm³ to 1.5 g/cm³.

Where the method of treating a substrate is a cleaning method then preferably the solid particles have lower densities so as to be kinder to the substrate, for example so as to lessen the tendency to damage or abrade the substrate. Thus, densities of no more than 3.0 g/cm³, no more than 2.5 g/cm³, no more than 1.8 g/cm³, no more than 1.6 g/cm³, no more than 1.5 g/cm³, and no more than 1.4 g/cm³ are of value in cleaning methods according to the present invention. Thus, when the method of treating a substrate is a cleaning method then preferably the density of the solid particles is from 1.0 g/cm³ to 3.0 g/cm³ and especially from 1.1 g/cm³ to 1.5 g/cm³.

Preferably, the solid particles are denser than the liquid medium, more preferably denser than water and especially more dense than water comprising relevant amounts of any optional additives.

In increasing preference, the solid particles preferably, have a size of no more than 50 mm, no more than 40 mm, no more than 30 mm, no more than 25 mm, no more than 20 mm, no more than 15 mm or no more than 10 mm.

In increasing preference, the solid particles preferably, have a size of at least 0.5 mm, at least 1 mm, at least 2 mm, at least 3 mm, at least 4 mm, at least 5 mm, at least 6 mm, at least 7 mm, or at least 8 mm.

Therefore, it is preferred that the solid particles have a size of from 0.5 mm to 40 mm, more preferably from 1 mm to 30 mm, especially from 2 mm to 20 mm, more especially from 3 mm to 15 mm and most especially from 4 mm to 10 mm.

The size is preferably a mean size, more preferably an arithmetic mean size. The arithmetic mean is preferably taken from a sample size of at least 100, at least 1,000 or at least 10,000 solid particles.

The size is preferably the longest linear dimension of the solid particle. The method of measuring the particle size is preferably performed by using callipers or a particle size measurement using image analysis, especially dynamic image analysis. A preferred apparatus for dynamic image analysis is a Camsizer as provided by Retsch. The mean size is preferably a number-weighted mean size.

The surface area of a solid particle is preferably from 10 mm² to 400 mm², more preferably from 40 mm² to 200 mm² and especially from 50 mm² to 190 mm².

Preferably, the ratio of solid particles to substrate is from 30:1 to 0.1:1 w/w (based on the dry mass of substrate), more preferably from 10:1 to 0.2:1 w/w, with particularly favourable results being achieved with a ratio from 5:1 and 0.2:1 w/w, and most particularly from 1:1 w/w and 0.5:1 w/w.

Preferably, the solid particles are re-used, that is to say that they are re-used in the method of the first aspect of the present invention.

In order of preference the solid particles are preferably re-used in said method at least 2, at least 3, at least 4, at least 5, at least 10, at least 20, at least 50, at least 100, at least 200, at least 300, at least 400 and at least 500 times. Preferably, the solid particles are re-used no more than 50,000 times, more preferably no more than 20,000 times, even more preferably no more than 10,000 times, especially no more than 5,000 times. It was especially surprising to the present inventors that solid particles as used in the present invention could survive so many repeated uses in the present method whilst simultaneously exhibiting good biodegradability in natural environments. When the solid particles are re-used in said method this means using the solid particles in the first and second steps, preferably each time the first step is repeated a different substrate is used.

Thus, preferably the method of the present invention is a method for treating multiple batches, wherein a batch comprises at least one substrate, the method comprising the afore-mentioned first step of agitating a composition comprising said solid particles, said liquid medium and a batch comprising at least one substrate, wherein said method further comprises the steps of:

(a) the afore-mentioned second step comprising separating said solid particles from said batch comprising at least one substrate;
(b) agitating a further batch comprising at least one substrate with solid particles separated from step (a); and
(c) optionally repeating steps (a) and (b) for subsequent batch(es) comprising at least one substrate.

The treatment procedure of an individual batch typically comprises the steps of agitating a composition comprising the batch, said solid particles and said liquid medium in a treatment apparatus for a treatment cycle. A treatment cycle typically comprises one or more discrete treatment step(s), optionally one or more rinsing step(s), one or more step(s) of separating the solid particles from the treated batch (a “separation step”), optionally one or more extraction step(s) of removing liquid medium from the treated batch, optionally one or more drying step(s), and optionally the step of removing the treated batch from the apparatus.

More preferably, the solid particles are re-used in said method at least 10 times.

The present inventors have found that after prolonged repeats of the method of the present invention using the same solid particles, the particles eventually reach an embrittlement point. The embrittlement point is preferably characterised as the point at which the solid particles begin to behave in a brittle and/or friable manner. Initially, the solid particles are highly resistant to, for example, compressive loads and show little or no tendency to crack or splinter under such compressive loads. The present inventors consider that a slow hydrolytic degradation of the biodegradable polyester in the solid particles is a significant contributor to the eventual embrittlement of the solid particles. The tendency towards embrittlement has also been seen to correlate with a reduction in the number-average molecular weight. It has been observed experimentally by the present inventors that the point of embrittlement corresponds to a number-average molecular weight of just below 30,000 Daltons, or just below 10,000 Daltons. It will be appreciated that this corresponds to the lower boundary of the present invention so far as molecular weight is concerned. The embrittlement of the solid particles may be measured using known methods in the art, such as by the compression testing on an Instron 3345 using a 5 kN load cell. The embrittlement point was the point at which a drop in force with increased displacement was observed to produce a visible crack in the solid particle, signifying that the mechanical strength of the particle was compromised. At a number averaged molecular weight of 10,000 Daltons and below it has been observed that the solid particles become much less robust and are easily mechanically damaged. Thus, solid particles comprising polyesters having such number average molecular weights are much less suitable for use in the present invention.

The present inventors also found experimentally that if the molecular weight of the biodegradable polyester were above 500,000 Daltons then the formation of the solid particles (for instance, via hot melt extrusion) becomes difficult as the flow rates and processability of the polyester undesirably decreases. In addition, it was also found that if the molecular weight was too high then whilst many repeats of the method of the invention could be desirably performed before embrittlement, the solid particles are less quickly biodegradable, especially in fresh water and especially at the lower temperatures (for instance under 20° C.) which are commonly encountered in the natural environment.

Advantageously, by increasing or decreasing the molecular weight in the range of 10,000 Daltons to 500,000 Daltons the present inventors are able to preferentially select:

A. excellent shape, substrate care and rapid natural biodegradation of the solid particles after use; or
B. longevity in the method of treatment according to the first aspect of the invention, mechanical robustness and resistance to treatments during higher temperatures.

Here the characteristics in group A predominate at the lower end of the molecular weight range, whilst those in group B predominate at the higher end of the molecular weight range.

The biodegradable polyester can be a homopolymer or a copolymer. In a preferred embodiment, the biodegradable polyester is a homopolymer.

A solid particle may comprise one or more different types of biodegradable polyester. Where a solid particle comprises more than one type of biodegradable polyester, these can be present within the same polymer molecule as a copolymer or they may be present as a physical blend of homopolymers or copolymers.

The method of the present invention as defined herein requires that a plurality of solid particles comprising biodegradable polyester is agitated with a liquid medium and a substrate. Such a plurality of solid particles may comprise one or more different types of biodegradable polyester. Where said plurality of solid particles comprise more than one type of biodegradable polyester, any given particle may comprise only one type of biodegradable polyester or more than one type of biodegradable polyester as described above.

Preferably, the biodegradable polyester is obtained by polymerizing one or more monomers at least one of which is selected from lactic acid (IUPAC 2-hydroxypropanoic acid), lactide, glycolic acid, hydroxy butyric acid, 3-hydroxy propionic acid, hydroxy valeric acid and caprolactone, including salts thereof. More preferably, the biodegradable polyester is obtained by polymerizing one or more monomers at least one of which is lactic acid or lactide, and especially lactide, including salts thereof.

Even more preferably, the biodegradable polyester is obtained by ring opening polymerisation of one or more monomers at least one of which is a cyclic ester, preferably lactide.

Salts may be of any kind without limitation but suitable salts for biodegradable polymers preferably include alkali metal salts (e.g. sodium, potassium and lithium salts), group II metal salts (especially magnesium and calcium) as well as ammonium and quaternary ammonium salts.

Preferably, the biodegradable polyester has a solidus of from 160° C. and 250° C., more preferably from 160° C. and 230° C. The solidus is the temperature of the onset of the melting phase of the biodegradable polyester. The solidus of the biodegradable polyester can be measured using known methodologies in the art, in particular using Differential Scanning calorimetry (DSC).

Preferably, the glass transition temperature (Tg) of the biodegradable polyester is at least 50° C., more preferably at least 60° C. Preferably, the biodegradable polyester has a Tg of no more than 80° C., more preferably no more than 70° C.

Preferably, the melting point of the biodegradable polyester is from 100° C. to 200° C., more preferably from 120° C. to 180° C., especially from 140° C. to 170° C. and most especially from 150° C. to 160° C.

It is preferred that the Tg and melting point are established by conventional DSC techniques (preferably using a sample size of 5 mg and a heating rate of 10° C./min). The value of Tg is preferably determined as the extrapolated onset temperature of the glass transition observed on the DSC scan (heat flow (W/g) against temperature (° C.)), for instance as described in ASTM E1356-98. The melting point is suitably determined from the DSC scan as the peak endotherm of the transition.

Preferably, the biodegradable polyester comprises hydrolysable groups within the backbone of the polymer, wherein the backbone of the polymer is defined as the longest series of covalently bonded atoms.

Preferably, the biodegradable polyester comprises at least 1 wt %, at least 5 wt %, at least 10 wt %, at least 20 wt %, at least 30 wt % and most especially at least 50 wt % of alkyl esters, preferably wherein said alkyl esters are monomeric repeating units derived from the aliphatic compounds described above, namely lactic acid (IUPAC 2-hydroxypropanoic acid), lactide, glycolic acid, hydroxy butyric acid, 3-hydroxy propionic acid, hydroxy valeric acid and caprolactone, and more preferably wherein said alkyl esters are monomeric repeating units derived from lactic acid and/or lactide, and especially from lactide. The remaining components of the biodegradable polyester suitably comprise aryl ester or esters comprising both aryl and alkyl groups, preferably wherein said esters are monomeric repeating units derived from the aromatic group-containing compounds. Such alkyl esters and aryl-containing esters suitably form the backbone of the biodegradable polyester.

One simple method for determining the backbone composition is to fully hydrolyse the polyester by means of acid and optionally heating and then analysing the monomeric components, for instance by gel permeation chromatography (GPC). Alternatively, the biodegradable polyester composition can be established by NMR or mass spectrometry.

The biodegradable polyester comprises hydrolysable ester groups. By “ester group” we mean the —C(═O)—O— unit, which in the biodegradable polyester is bound at each end to a carbon atom. By “alkyl ester” we mean an —R—C(═O)—O— unit wherein R is an alkylene group.

In one embodiment, the biodegradable polyester is polylactic acid or polylactide, i.e. a polyester characterised by the repeat unit —[CH(CH₃)—CO—O]—, and preferably having the formula CH₃—CH(OH)—CO—O—[CH(CH₃)—CO—O]ₙ—CH(CH₃)—CO—OH wherein n is an integer defined as the degree of polymerisation (wherein n suitably provides the preferred molecular weights referred to herein above).

The biodegradable polyester may be completely amorphous, completely crystalline or semi-crystalline (i.e. containing both crystalline and amorphous regions). Typically, the biodegradable polyester is semi-crystalline. The biodegradable polyester is preferably at least partially amorphous.

The number-average molecular weight of the biodegradable polyester is the total weight of the polymer sample divided by the total number of molecules in the sample.

The number-average molecular weight is preferably established by GPC. The solvent is preferably tetrahydrofuran (THF). The standard used to calibrate the molecular weight is preferably polystyrene.

Preferably, the biodegradable polyester has a number-average molecular weight of at least 15,000 Daltons, more preferably at least 20,000 Daltons, even more preferably at least 30,000 Daltons and especially at least 40,000 Daltons.

It is especially preferred that the biodegradable polyester has a number-average molecular weight of from 30,000 Daltons to 500,000 Daltons.

Preferably, the biodegradable polyester has a number-average molecular weight of no more than 450,000, especially no more than 400,000, more especially no more than 300,000 and particularly no more than 200,000 Daltons.

Preferably, when the solid particles comprise a biodegradable polyester with a number-average molecular weight of at least 30,000 Daltons then the method of the present invention can be repeated at least 100 times, more especially at least 1,000 times this is especially so when the liquid medium during the first step of said method is always no more than 70° C., more preferably always no more than 60° C. and especially always no more than 50° C., preferably wherein the liquid medium during the first step of said method is always at least 0° C., more preferably always at least 5° C.

One especially desirable characteristic of the solid particles comprising biodegradable polyester is fabric care, so alongside treating the substrates, there is a high preference for solid particles that have a low propensity to damage the surface of the substrate. Such damage can be especially visible or noticeable, for instance, in substrates which have raised patterns or features. Thus, the solid particles comprising biodegradable polyester preferably have a balance between a polymer which is flexible yet also has a certain degree of rigidity. An entirely or predominantly flexible solid particle comprising biodegradable polyester would not provide the level of fabric care needed. It is preferable that the solid particles have a Young's modulus from 1 GPa to 6 GPa, preferably from 2 to 5 GPA. The Young's modulus is measured using conventional methods known in the art, for instance as described in ASTM E111.

Substrate

Preferably, the substrate is pliable and especially flexible.

In a preferred embodiment, the substrate is or comprises a textile, a fibre or a yarn.

In a further preferred embodiment, the substrate is or comprises an animal skin.

When the substrate is or comprises a textile, a fibre or a yarn, the method of treating of the first aspect of the invention is preferably cleaning (especially laundering), dyeing, abrading, fading, desizing or biofinishing.

When the substrate is or comprises a textile, the textile may comprise either a natural fibre, such as cotton or a synthetic fibre, for example nylon 6,6 or a polyester, or a blend of natural and synthetic fibres.

When the substrate is or comprises an animal skin. The animal skin may be in the form of a hide, a pelt, or untreated, partially or fully treated leather. The skin can be taken from a mature or juvenile animal. The animal may be a mammal, more preferably a ruminant and especially livestock such as goats, pigs, sheep and especially cows. It will be appreciated that human skins are not within the scope of the term “animal skins” in the context of the present invention.

In a further preferred embodiment, the substrate is or comprises plastic, paper, ceramic, metal, glass, wood or a combination thereof.

Most preferably, the substrate is or comprises a textile, a fibre, a yarn or an animal skin.

The substrate can be soiled or clean prior to the method of treating according to the first aspect of the present invention.

When the method of treating comprises cleaning (or laundering) the substrate is preferably soiled before the method according to the first aspect of the present invention is performed, that is to say prior to the first step.

When the method of treating is or comprises tanning or a tannery process or when the method of treating is or comprises dyeing, abrading, fading, desizing and biofinishing then the substrate is preferably clean prior to the method of treatment according to the first aspect of the present invention, that is to say prior to the first step.

The soil, when present on the substrate, may be in the form of, for example, dust, dirt, foodstuffs, beverages, animal products such as sweat, blood, urine, faeces, and/or plant materials such as grass, and inks and paints.

The Liquid Medium and Composition Used in the Method of the Invention

Preferably, the liquid medium is aqueous. By “aqueous” we mean that the liquid medium preferably, is or comprises water. Where water is used in conjunction with other liquids, these liquids may be organic liquids such as alcohols, esters, ethers, amides and the like.

Preferably, the composition which is agitated in the method of the first aspect of the invention comprises water (as the liquid medium) and a treatment agent along with the substrate and the solid particles. Treatment agents include, but are not limited to, surfactants, enzymes, bleaches and organic liquids.

In order of increasing preference, the liquid medium comprises at least 50 wt %, at least 60 wt %, at least 70 wt %, at least 80 wt %, at least 90 wt %, at least 95 wt % or at least 99 wt % of water. The remainder required to reach 100% is preferably one or more of the abovementioned organic liquids. Most preferably, the liquid medium consists of water and no other organic liquids.

Preferably, the liquid medium has a pH of from pH 3 to pH 13. The pH of the liquid medium can be adapted to the substrate and application to which the method of treatment is applied. For example in a leather treatment, such as tanning, the pH is typically initially acidic (i.e. below pH 7) to open out the animal skin structure and then the pH is preferably basic (i.e. greater than pH 7) to fix any leather treatment additives to the animal skin. For cleaning and especially laundry methods, so as to enhance fabric care, milder conditions are preferred and typically the pH of the liquid medium is from pH 7 to pH 12, more typically pH 8 to pH 12.

Preferably, the composition which is agitated in the method of the first aspect of the invention comprises a surfactant and/or an enzyme.

Preferably, when the method of treating a substrate is or comprises a cleaning method, such as a laundry method, the composition preferably comprises a surfactant, and/or an enzyme.

Preferably, the treating is or comprises cleaning. Preferably, in a treatment which is or comprises cleaning or laundry the composition contains a surfactant, wherein the surfactant has detergent properties. The surfactant may comprise anionic, non-ionic, cationic, amphoteric and/or zwitterionic surfactants. The composition optionally further comprises oxygen- or chlorine-derived bleaches in addition to said surfactants.

Preferably, in a treatment which is or comprises cleaning or laundry the composition contains one or more enzymes, preferably wherein the one or more enzymes comprise amylases, lipases and proteases.

Temperature

Preferably, the liquid medium has a temperature of no less than 0° C., more preferably no less than 5° C. and especially no less than 10° C. during at least a part, more preferably at least 50% and preferably all of the duration of the first step and optionally the second step.

In order of increasing preference, the liquid medium has a temperature of no more than 100° C., no more than 90° C., no more than 80° C., no more than 70° C., no more than 60° C., no more than 50° C. and no more than 40° C. during at least a part, more preferably at least 50% and preferably all of the duration of the first step and optionally the second step. Preferably, the solid particles do not experience a liquid medium having a temperature of 70° C. or more for any one period having a duration of more than 2 hours.

Where the method of treating is or comprises a cleaning method such as laundry, then according to the present invention an excellent cleaning performance may be achieved whilst using significantly reduced levels of detergents and lower temperatures. Thus, as an example, methods concerned with textile cleaning according to the invention may be carried out at temperatures not exceeding 65° C., and optimum environmental benefits are generally achieved at temperatures of from 5° C. to 40° C. Although temperatures greater than 40° C. can be used, generally this is not preferred.

Optionally, the liquid medium has a temperature of from 5° C. to 70° C. during the first step.

Agitation

The agitation may be in the form of shaking, stirring, jetting, rotating and tumbling. Of these tumbling is especially preferred. Preferably, the substrate, liquid medium and solid particles are added into a rotatable drum which is rotated so as to cause tumbling. The agitation by means of rotating the drum may be continuous or intermittent.

Time

Preferably, the method is performed for a period of from 1 minute to 600 minutes, more preferably, from 5 minutes to 180 minutes and even more preferably from 20 minutes to 120 minutes.

This period is preferably the duration of the first and second steps combined.

End of Use for the Solid Particles

The method according to the first aspect of the present invention preferably also comprises the additional step of determining the number-average molecular weight of the biodegradable polyester in the solid particles. This is preferably done by using Gel Permeation Chromatography as described above. The solid particles are removed and replaced with fresh solid particles when the number-average molecular weight falls below 10,000 Daltons. This has several advantages. Firstly, it helps to ensure that embrittled solid particles are not used in the method of the present invention. Secondly, it ensures that expended or used solid particles are now ideally suited to subsequent rapid biodegradation in the natural environment. In essence, only a little more hydrolysis and biodegradation will result in now desirable fragmentation and breakdown in the natural environment.

Apparatus

The method according to the first aspect of the present invention is preferably performed in an apparatus comprising a rotatable drum. Preferably, the user loads the substrate into the rotatable drum. Preferably, the apparatus delivers the liquid medium into the rotatable drum. Preferably, the apparatus dispenses the solid particles into the rotatable drum. The apparatus preferably then rotates the drum so as to agitate the composition comprising substrate, solid particles and liquid medium. In the case of treatment which is cleaning, this is often referred to as the wash part of the cycle. When the first step of agitation is complete, the apparatus preferably automatically separates the solid particles from substrate. The solid particles may be separated by means of apertures located in the surface of the rotatable drum or in elongate projections (commonly referred to as lifters) located on the inner surface of the rotatable drum. These apertures may direct the solid particles, optionally via one or more flow paths, to a storage compartment or compartments. Said storage compartment(s) may be located outside of and separate from the rotatable drum (e.g. in a sump) or integral with the drum (especially within a storage compartment located towards the rear of the drum). Preferably, the apparatus has an access means for loading the substrate into the rotatable drum, wherein the access means is typically in the form of a door.

The word multiplicity as used herein preferably means at least 100, more preferably at least 1,000 solid particles.

Suitable apparatus is described in PCT patent publications WO2007/128962, WO2011/098815, WO2014/147389, PCT/GB/2017/053815.

In the present invention, any items expressed in the singular are also intended to encompass the plural unless stated to the contrary. Thus, words such as “a” and “an” mean one or more.

The present invention will now be illustrated by the following non-limiting examples.

### EXAMPLES

Materials

Polylactide material was obtained from Natureworks LLC under the tradename Ingeo 2003D.

The Polylactide material was hot melt extruded using a twin screw extruder and underwater cut into particles having an average size of 4 mm for one batch (hereinafter PLA-1) and 6.5 mm for another batch (hereinafter PLA-2). The size being the longest linear dimension. The polylactide within PLA-1 had a number average molecular weight of approximately 56,000 Daltons. The polylactide within PLA-2 had a number average molecular weight of approximately 73,000 Daltons. The molecular weights were determined by GPC using at 40° C. in tetrahydrofuran.

Nylon 6 was twin screw extruded with barium sulphate in a weight ratio of 55 wt % Nylon to 45 wt % barium sulfate and underwater cut into particles having an average size of 4 mm for one batch (Nylon-1) and 6 mm for another batch (Nylon-2). The size again being the longest linear dimension.

The detergents used in the treating of the substrates were Tide HE which is manufactured by Procter and Gamble and Pack 1 which is a detergent available from Xeros.

Pack 2 is an oxidizing stain remover which is supplied by Xeros.

The substrate used in some of the treatments were EMPA 108 stain sheets which were obtained from Swissatest, these sheets had dimensions of approximately 12 cm by 12 cm and comprised a mixture of standard stains to be cleaned.

In order to add realistic levels of soiling into some treatments SBL2004 sebum sheets obtained from WFK were used. These add soil into the treatment step in a realistic way.

### CLEANING EXAMPLES

### Cleaning Example 1

A Xeros washing machine having a loading capacity of 25 Kg of dry substrate as described in PCT patent publication WO 2011/098815 was used to treat (clean) the substrates in accordance with the present invention. The Xeros washing machine was loaded with a 20 Kg load comprising a British Standard ballast comprising a mixture of towels (EMPA 351), sheets (EMPA352) and pillow cases (EMPA353). In addition, 6 EMPA 108 stain sheets, 10 sebum sheets both as described in the materials section were loaded into the Xeros washing machine.

Pack 1 detergent (250 g) as described in the materials section was used for each wash load to assist the cleaning.

Solid particles (25 kgs) in the form of PLA-1 as described in the materials section were used.

Water was used as the liquid medium.

The treatment was cleaning which was performed for a period of 1 hour at a temperature of 20° C. The Xeros washing machine agitated (tumbled) the composition comprising the solid particles, the water, the substrate (EMPA 108 stain sheets) and the detergent (Pack 1).

The Xeros washing machine automatically separated the solid particles from the substrate towards the end of the 1 hour period and moved the solid particles to a separate sump.

The washing machine contents were then unloaded. The EMPA 108 stain sheets were removed from the washload, ironed using a trouser press and left overnight to dry and acclimatise.

Test Methodology

EMPA108 stain sheets obtained from Cleaning Example 1 were measured using a spectrophotometer from Konica Minolta with model number CM3600A. Each stain is measured 4×, twice on each side and an average Y value is recorded for each stain type. There were five stain types on each EMPA stain sheet. The “Sum of Y” value is then taken as the sum of each of the five average Y values for each stain.

### Comparative Cleaning Example 1

Comparative Cleaning Example 1 was performed in exactly the same way as Cleaning Example 1 except that the solid particles were replaced with 25 Kg of Nylon-1 as described in the materials section.

Results

The Sum of Y values for Cleaning Example 1 and Comparative Cleaning Example 1 were as indicated below in Table 1.

TABLE 1

| | Solid Particle | Sum |
|---|---|---|
| Example | type | of Y |
| Cleaning Example 1 | PLA - 1 | 306 |
| Comparative Cleaning | Nylon - 1 | 301 |
| Example 1 | | |

In this set of results a higher Sum of Y value indicates a better effectiveness of the cleaning. These results showed that, within the error margins of experimentation, the cleaning performance of the present invention is at least as good if not better than the known art which uses non-biodegradable polymers such as Nylon.

Biodegradability Testing

Solid particles (PLA-1) as described in the materials section were submersed in slightly salty water at a temperature 20° C. for a period of 6 months. After this submersion the number average molecular weight of the polymer in the solid particles was remeasured and found to be 49,000 Daltons. Thus, in the 6 months' time period the molecular weight had reduced by approximately 12%. Clearly, seawater is actively biodegrading the polyester present in the solid particles.

In contrast, Nylon-1 particles are known to be substantially invulnerable to biodegradation.

### Cleaning Example 2

A Xeros washing machine having a loading capacity of 8 Kg of dry substrate as described in PCT patent publication WO2018/172725 was used to treat (clean) the substrates in accordance with the present invention. The Xeros washing machine was loaded with a 5.5 Kg load comprising a real-world substrates comprising a mixture of t-shirts, long sleeved shirts, polo shirts, jumpers, hoodies, children's clothing and jeans. In addition, 1 sebum sheet as described in the materials section was loaded into the Xeros washing machine.

Tide HE (22.5 g) as described in the materials section was used for each wash load to assist the cleaning.

Solid particles (5 kgs) in the form of PLA-2 as described in the materials section were used.

Water was used as the liquid medium.

The treatment was cleaning which was performed for a period of 1 hour at a temperature of 20° C. The Xeros washing machine agitated (tumbled) the composition comprising the solid particles, the water, the substrates and the detergent (Tide HE).

The Xeros washing machine automatically separated the solid particles from the substrate towards the end of the 1 hour period and moved the solid particles to a storage compartment in a rear portion of the drum.

The washing machine contents were then unloaded. Whilst unloading the substrates any solid particles remaining in or on the substrates were separated by hand and counted. The total number of remaining solid particles was then calculated.

Cleaning Example 2 was repeated a further 4 times (to a total of 5 times) and an average value for the total number of remaining solid particles was then calculated.

### Comparative Cleaning Example 2

Comparative Cleaning Example 2 was performed in exactly the same way as Cleaning Example 2 (including the 4 repeats thereof) except that the solid particles used were Nylon-2,

Results

The average total numbers of remaining solid particles were as indicated in Table 2.

TABLE 2

| | Solid Particle | Average remaining |
|---|---|---|
| Example | type | total solid particles |
| Cleaning Example 2 | PLA - 2 | 33 |
| Comparative Cleaning | Nylon - 2 | 82 |
| Example 2 | | |

A higher average number of remaining total solid particles is undesirable as such particles must be manually removed. Surprisingly, the solid particles used in the present invention resulted in markedly superior automatic separation in the Xeros washing machine.

Re-Usability

### Cleaning Example 3

A Xeros washing machine having a loading capacity of 25 Kg of dry substrate as described in PCT patent publication WO 2011/098815 was used to treat (clean) the substrates in accordance with the present invention. The Xeros washing machine was loaded with a 20 Kg load comprising substrates comprising a mixture of towels (EMPA 351), sheets (EMPA352) and pillowcases (EMPA353). In addition, 4 sebum sheets both as described in the materials section were loaded into the Xeros washing machine.

Pack 1 (250 g) and Pack 2 (250 g) as described in the materials section were used for each wash load to assist the cleaning.

Solid particles (25 kgs) in the form of PLA-1 as described in the materials section were used.

Water was used as the liquid medium.

The treatment was cleaning which was performed for a period of 1 hour and 10 minutes at a temperature of 40° C. The Xeros washing machine agitated (tumbled) the composition comprising the solid particles, the water, the substrate and the detergent (Packs 1 and 2).

The Xeros washing machine automatically separated the solid particles from the substrate towards the end of the 1 hour and 10 minutes period and moved the solid particles to a separate sump.

The washing machine contents were not unloaded between repeat cleaning cycles.

The cleaning cycles were repeated to a total of 250 and 500 cycles. The same solid particles and load were used for every repeat but fresh water and detergent were used for each separate cleaning cycle.

At 250 and 500 cycles the number averaged molecular weight of the polyester in PLA-1 solid particles was re-measured.

Results

The molecular weights and the visual appearance of the solid particles at 0, 250 and 500 wash cycles was as tabulated in Table 3.

TABLE 3

| Cleaning | Solid Particle | Molecular weight | Visual |
|---|---|---|---|
| Example 3 | type | (Mn) | appearance |
| 0 cycles | PLA - 1 | 56,000 | Solid particles |
| | | | with no visible |
| | | | softening or |
| | | | disintegration. |
| 250 cycles | PLA - 1 | 53,400 | Solid particles |
| | | | with no visible |
| | | | softening or |
| | | | disintegration. |
| 500 cycles | PLA - 1 | 52,700 | Solid particles |
| | | | with no visible |
| | | | softening or |
| | | | disintegration. |

In Table 3 it was clearly seen that the biodegradable polyester in the solid particles was surprising capable of providing cleaning performance over at least 500 repeat cycles even at an elevated temperature of 40° C. The molecular weight and visual appearance results both confirm that many hundreds of repeat cycles are perfectly possible. What was additionally surprising was that this particular example used substantially high levels of detergent and stain remover.

The present inventors have also performed experiments similar to Cleaning Example 3 which differ in that the temperature during the wash cycle was even higher at 60° C. and using even more aggressive cleaning chemistry including cleaning agents such as oxalic acid, sodium hypochlorite, sodium hydroxide, sodium metabisulfite, Rexasol plus (a non-ionic detergent) and Xeros Pack 1. The results of this experiment also showed that solid particles comprising PLA-1 were capable of cleaning effectively for at least 50 re-use cycles.

1. A method of treating a substrate comprising a first step of agitating a composition comprising solid particles comprising biodegradable polyester having a number-average molecular weight of from 10,000 Daltons to 500,000 Daltons, said solid particles having a size of from 0.1 mm to 100 mm; a liquid medium; and the substrate, and a second step comprising separating the solid particles from the substrate.

2. A method according to claim 1 wherein solid particles separated in said second step are re-used in a further method comprising said first and second steps defined in claim 1.

3. A method according to claim 2 wherein the solid particles are re-used at least 10 times.

4. A method according to any of the preceding claims wherein the biodegradable polyester has a number-average molecular weight of from 30,000 Daltons to 500,000 Daltons.

5. A method according to any one of the preceding claims wherein the biodegradable polyester has a solidus of from 160° C. and 250° C.

6. A method according to any one of the preceding claims wherein the biodegradable polyester is obtained by polymerizing one or more monomers at least one of which is selected from lactic acid, lactide, glycolic acid, hydroxy butyric acid, 3-hydroxy propionic acid, hydroxy valeric acid and caprolactone, including salts thereof.

7. A method according to claim 6 wherein the biodegradable polyester is obtained by polymerizing one or more monomers, at least one of which is lactic acid or lactide including salts thereof.

8. A method according to any one of the preceding claims wherein the biodegradable polyester is obtained by ring opening polymerisation of one or more monomers, at least one of which is a cyclic ester.

9. A method according to claim 8 wherein the biodegradable polyester is obtained by ring opening polymerisation of one or more monomers, at least one of which is lactide.

10. A method according to any one of the preceding claims wherein the biodegradable polyester is completely or partially in the amorphous state.

11. A method according to any one of the preceding claims wherein the solid particles comprise the biodegradable polyester and no filler.

12. A method according to any one of the preceding claims wherein the substrate is pliable.

13. A method according to any one of the preceding claims wherein the substrate is or comprises a textile, a fibre, or a yarn.

14. A method according to any one of the preceding claims wherein the substrate comprises an animal skin.

15. A method according to any one of the preceding claims wherein the liquid medium comprises water.

16. A method according to any one of the preceding claims wherein the liquid medium has a pH in the range of from pH 3 to pH 13.

17. A method according to any preceding claims wherein the composition comprises a surfactant and/or an enzyme.

18. A method according to any one of the preceding claims wherein the liquid medium has a temperature of from 5° C. to 70° C. during the first step.

19. A method according to any of the preceding claims wherein treating is or comprises cleaning.

20. A method according to claim 19 wherein the substrate is soiled prior to the first step.

21. A method according to any one of the preceding claims wherein at least some of the solid particles have a shape which is spheroidal or ellipsoidal.

22. A method according to any one of the preceding claims wherein the solid particles comprise no releasable material.

23. A method according to any one of the preceding claims wherein all of the solid particles present comprise said biodegradable polyester.

24. A method according to any one of the preceding claims wherein the biodegradable polyester is insoluble in water.

25. A method according to any one of the preceding claims which comprises the additional step of determining the number-average molecular weight of the biodegradable polyester in the solid particles and removing and replacing the solid particles with fresh solid particles when the number-average molecular weight falls below 10,000 Daltons
